(19) United States
(12) Patent Application Publication
(10) Pub. No.: US 2010/0181145 A1
(43) Pub. Date: Jul. 22, 2010

(54) DESCENT DEVICE

(75) Inventor: Eric Hobson, Western Australia (AU)

Correspondence Address: WOOD, HERRON & EVANS, LLP, 2700 CAREW TOWER, 441 VINE STREET, CINCINNATI, OH, 45202, US

(73) Assignee: LIFELINE DESCENT SYSTEMS PTY LTD, Wangara, Western Australia (AU)

(21) Appl. No.: 12/665,750

(22) PCT Filed: Jun. 17, 2008
(86) PCT No.: PCT/AU2008/000871

§ 371 Date: Mar. 26, 2010

(30) Foreign Application Priority Data
Jun. 25, 2007 (AU) 2007903406

(51) Int. Cl. A62B 1/10; F16H 57/08; F16D 59/00

(52) U.S. Cl. 182/234; 475/331

(57) ABSTRACT

There is disclosed herein a descent device (10) comprising a hollow spool (12) rotatable about a rotational axis (14) and a lifeline, in the form of a braided steel cable (not shown), wound about the spool (12). A centrifugal brake mechanism (18) including a brake assembly, comprising a pair of brake shoes (20) and associated brake pads (21), is engageable with the spool (12) to apply a braking force to the spool (12) as the spool (12) rotates. Biasing members, in the form of a compression springs (22), extend between the brake shoes (20) for biasing the brake shoes (20) and pads (21) into engagement with the spool (12).

### TECHNICAL FIELD

The present invention relates to a device for evacuation of inhabitants from multi-storey buildings and, in particular, to a descent device for allowing inhabitants to lower themselves in a controlled manner from such a building.

The present invention has been developed for use in evacuating inhabitants from multi-storey buildings in emergency situations, such as where lifts and/or stairwells are inoperable, overcrowded or otherwise unusable. However, it will be appreciated that the invention is not limited to this particular field, and may also be used, for example, in construction and maintenance of multi-storey buildings, operation of oil and gas rigs, mountaineering, as well on cranes and operating platforms.

### BACKGROUND OF THE INVENTION

Known devices for evacuating inhabitants from multi-storey buildings include centrifugal braking devices, such as that disclosed in U.S. Pat. No. 5,076,395. This device includes a lifeline that is selectively dispensed from a reel around which the lifeline is wound. A planetary gear mechanism and a centrifugal brake mechanism are housed within a cylindrical portion of the reel.

A disadvantage of the device of the '395 patent, however, is that substantial slack is generated in the lifeline prior to the centrifugal brake mechanism engaging. Accordingly, a user, the lifeline and an associated harness can experience a significant, and potentially dangerous, jolt when the brake mechanism does engage.

### OBJECT OF THE INVENTION

It is the object of the present invention to substantially overcome or at least ameliorate one or more of the above disadvantages.

### SUMMARY OF THE INVENTION

In a first aspect, the present invention provides a descent device comprising:
a hollow spool rotatable about a rotational axis;
a lifeline wound about the spool;
a centrifugal brake mechanism including at least one brake assembly engageable with the spool to apply a braking force to the spool as the spool rotates; and
a biasing member for biasing the at least one brake assembly into engagement with the spool.

The centrifugal brake mechanism is preferably continuously engaged with the spool. The centrifugal brake mechanism and the spool are preferably counter-rotating.

The biasing member is preferably adapted to provide sufficient friction between the spool and the at least one brake assembly to prevent rotation of the spool due to the weight of an initially unwound portion of the lifeline. The biasing member is preferably a compression spring. The spring is preferably adapted to provide a force of between around 10 N and around 100 N between the spool and the at least one brake assembly.

The centrifugal brake mechanism preferably includes a gear train including a ring gear engaged with the spool, at least one planetary gear engaged with the ring gear and a sun gear engaged with the at least one planetary gear. The sun gear is preferably rotationally engaged with a shaft that converts torque from the sun gear into a centrifugal force biasing the at least one brake assembly toward the spool. The gear ratio between the ring gear and the sun gear is preferably between 2:1 to 15:1, more preferably between 4:1 and 10:1 and most preferably around 6:1. Three of said planetary gears are preferably equally is spaced apart between the sun gear and the ring gear.

At least one brake shoe carrier plate is preferably rotationally engaged with the shaft and slidably engaged with the brake assembly to convert torque from the shaft into linear movement of the brake assembly in a direction substantially perpendicular to said rotational. The carrier plate preferably extends substantially perpendicularly relative to a longitudinal axis of the shaft. The at least one brake assembly preferably includes a slot adapted to slidably receive an end of the carrier plate. A first said carrier plate is preferably provided on one side of said at least one brake assembly and a second said carrier plate is preferably provided on an opposite side of said at least one brake assembly.

The centrifugal brake mechanism is preferably adapted to provide for a descent rate of between around 0.5 m/s and around 5 m/s when a 150 kg mass is connected to said lifeline and allowed to fall under gravity. More preferably, the descent rate is between around 1 m/s and around 2 m/s when a 150 kg mass is connected to said lifeline and allowed to fall under gravity.

Two said brake assemblies are preferably provided. One of said brake assemblies is preferably provided at one end of the carrier plate and another of said brake assemblies is preferably provided at an opposite end of the carrier plate. A compression spring preferably extends between the brake assemblies to bias the brake assemblies away from one another into engagement with the spool. The brake assembly(ies) preferably comprise(s) a brake shoe and a brake pad.

A first disc is preferably fixedly connected to one end of said spool and a second disc is preferably fixedly connected to an opposite end of said spool. The first and second discs preferably each include a central aperture for rotationally supporting the shaft. The at least one carrier plate is preferably sandwiched between a respective one of the first and second discs and the at least one brake assembly.

A housing is preferably provided for the spool, an unwound portion of the lifeline, the centrifugal brake mechanism and the biasing member. The housing is preferably substantially tamperproof to prevent tampering of components therein. A first inner side of the housing preferably includes bosses upon which the planetary gears are rotatably mounted.

In a second aspect, the present invention provides a method of deploying a lifeline, said method comprising the steps of:
providing a spool having a lifeline wrapped therearound;
providing a centrifugal brake mechanism including at least one brake assembly engageable with the spool to apply a braking force to the spool as the spool rotates;
biasing the brake assembly against the spool to resist rotation of the spool;
applying a weight to a free end of the lifeline and allowing the weight to fall under the influence of gravity.

The biasing of the brake assembly against the spool is preferably continuous.

### BRIEF DESCRIPTION OF THE DRAWINGS

A preferred embodiment of the present invention will now be described, by way of an example only, with reference to the accompanying drawings, in which:

FIG. 1 is a front elevational view of a preferred embodiment of a descent device according to the invention;

FIG. 2 a cross-sectional view taken along line 2-2 of FIG. 1;

FIG. 3 is a side elevational view of the descent device of FIG. 1;

FIG. 4 is a cross-sectional view taken along line 4-4 of FIG. 3;

FIG. 5 is a cross-sectional view taken along line 5-5 of FIG. 3;

FIG. 6 is a perspective view of the descent device of FIG. 1, with the housing removed to expose the gear train; and

FIG. 7 is a perspective cross-sectional view taken along line 4-4 of FIG. 1.

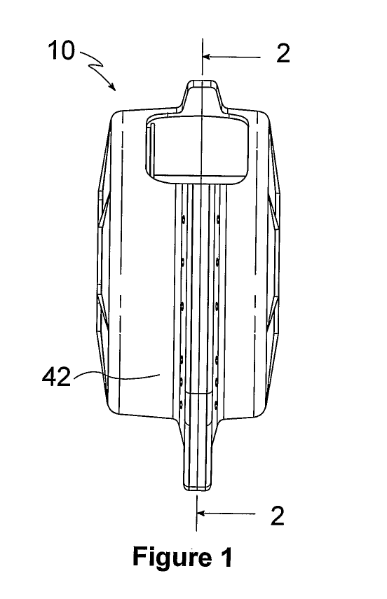

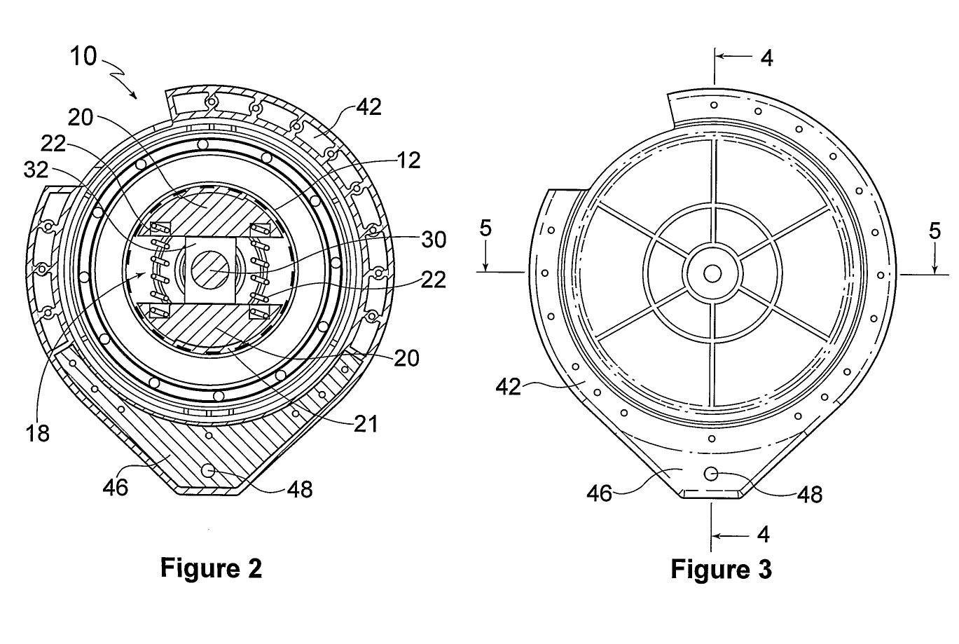

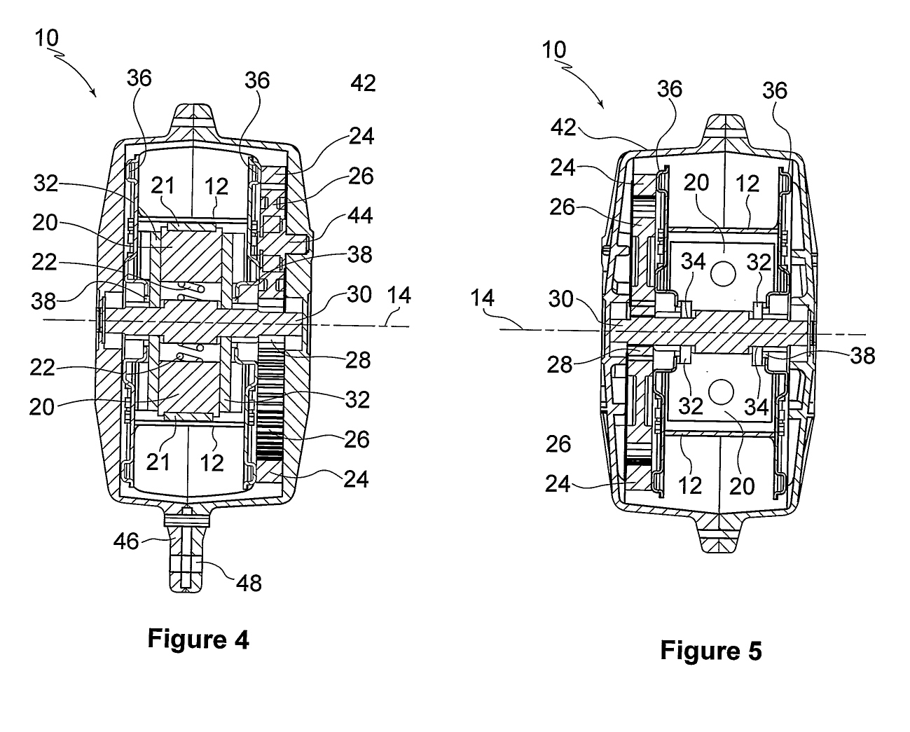

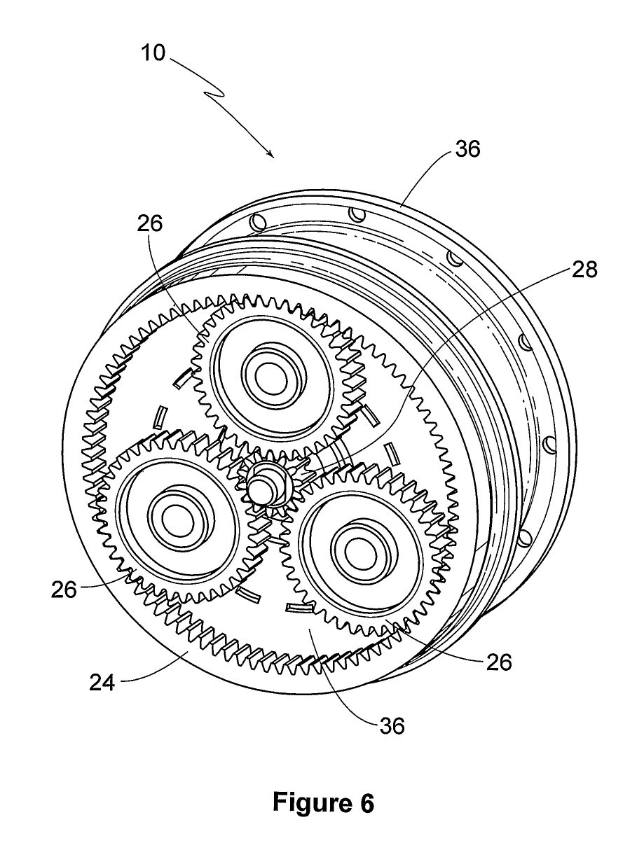

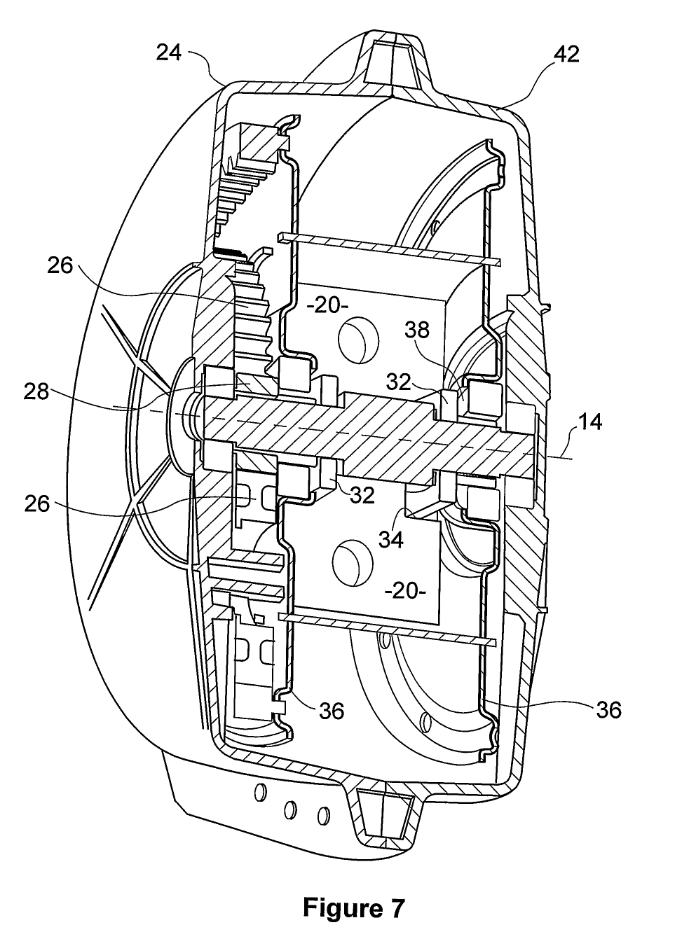

### DETAILED DESCRIPTION OF THE PREFERRED EMBODIMENT

Referring to the drawings, there is shown a descent device 10 comprising a hollow spool 12 rotatable about a rotational axis 14 and a lifeline, in the form of a braided steel cable (not shown), wound about the spool 12. A centrifugal brake mechanism 18 including a brake assembly, comprising a pair of brake shoes 20 and associated brake pads 21, is engageable with the spool 12 to apply a braking force to the spool 12 as the spool 12 rotates. Biasing members, in the form of a compression springs 22, extend between the brake shoes 20 for biasing the brake shoes 20 and pads 21 into engagement with the spool 12.

The compression spring 22 is adapted to provide sufficient friction between the spool 12 and the brake pads 21 to prevent rotation of the spool 12 due to the weight of an initially unwound portion of the cable. Accordingly, the spring 22 is adapted to provide a force of between around 10 N and around 100 N between the spool 12 and the brake pads 21.

The centrifugal brake mechanism 18 includes a gear train including a ring gear 24 engaged with the spool 12, three equally spaced apart planetary gears 26 engaged with the ring gear 24, and a sun gear 28 engaged with the planetary gears 26. The gear ratio between the ring gear and the sun gear is around 6:1. The sun gear 28 is rotationally engaged with a shaft 30, which extends substantially parallel to the rotational axis 14, to convert torque from the sun gear 28 into a centrifugal force biasing the brake shoes 20 toward the spool 12. The ring gear 24, planetary gears 26 and sun gear 28 each have a pressure angle of 25 degrees.

First and second brake shoe carrier plates 32 are each rotationally fixed to the shaft 30 and slidably engaged in a respective slot 34 on opposite sides of the brake shoes 20 to convert torque from the shaft 30 into linear movement of the brake shoes 20 in a direction substantially perpendicular to the rotational axis 14. The carrier plates 32 extend substantially perpendicularly relative to the rotational axis 14.

First and second discs 36 are each fixedly connected opposite ends of the spool 12, outwardly of the carrier plates 32. The discs 36 each include a central aperture 38 for rotationally supporting the shaft 30.

A housing 42 is provided for the spool 12, an unwound portion of the cable 16, the centrifugal brake mechanism 18 and the spring 22. The housing is substantially tamperproof to prevent tampering of components therein. A first inner side of the housing 42 includes three bosses 44 upon which the planetary gears 26 are rotatably mounted. An anchor plate 46 extends from the housing 42 and includes a mounting aperture 48 adapted for connection to an anchor point near an external window in a multi-storey building (not shown).

The spool 12 is formed from mild steel, the brake shoes 20 and carrier plates 32 from anodised aluminium, the brake shoe friction material from a standard friction material, the ring gear 24 and planetary gears 26 from nylon, the sun gear 28 from mild steel, the discs 36 from plate steel, the housing from plastics, and the anchor plate 46 from G250 steel. The total weight of the descent device is around 13 kg (around 5 kg without the cable).

In use, a user is connected to an end of the cable, via a harness (not shown), and then exits the building through the window. Due to the compression spring 22 biasing the brake is pads 21 into engagement with the spool 12, no slack accumulates in the cable 16. Accordingly, as the person descends under the influence of gravity and the cable 16 is unwound, the spool 12 rotates, which in turn causes the ring gear 24, planetary gears 26, sun gear 28, shaft 30 and brake shoes 20 to rotate, which in turn creates a centrifugal braking force biasing the brake shoes 20 outwardly toward the spool 12. Initially, the user accelerates downwardly until the sun gear achieves sufficient angular velocity to create a braking force equal to the weight of the user. However, the 6:1 ratio between the ring gear 24 and the sun gear 28 ensures that the braking force is adequate to maintain a descent rate of between 1 and 2 m/s for a user weighing up to 150 kg. The braking force is further enhanced by the brake shoes and the spool being counter-rotating.

The descent device 10 is stored, prior to use, in an air-tight blister pack (not shown) to safeguard its components against environmental exposure and tampering.

It will be appreciated that the illustrated descent device 10 allows a user to descent from a multi-storey building at a safe rate of between 1 m/s to 2 m/s. Moreover, due to the brake pads being continuously engaged by virtue of the springs 22, the cable cannot unwind under its own weight and, accordingly, no slack accumulates in the cable 16. Moreover, the user's descent is relatively smooth, as the brake mechanism 18 is continuously engaged and gradually increases its braking force until the braking force applied by the brake mechanism 18 and the user's weight reach equilibrium. Also, the tamperproof housing 42 ensures that the working components of the descent device cannot be tampered with, thereby ensuring reliable operation. The tamperproof housing 42 also ensures that the device cannot be re-used.

Whilst the present invention has been described with reference to a specific embodiment, it will be appreciated that it may also be embodied in many other forms. For example:
the lifeline may be formed from other high strength materials, such as a webbing of aramid fibres;
the sun gear may be formed from a high grade glass filled engineering plastic, such as, but not limited to, PEEK or PPS;
the anchor plate 46 may be formed from aluminium; and/or
other pressure angles may be adopted for the ring gear 24, planetary gears 26 and sun gear 28.

1. A descent device comprising:
a hollow spool rotatable about a rotational axis;
a lifeline wound about the spool;
a centrifugal brake mechanism including at least one brake assembly engageable with the spool so as to apply a braking force to the spool as the spool rotates; and
a biasing member adapted to bias the at least one brake assembly into engagement with the spool,
wherein the centrifugal brake mechanism and the spool are counter-rotating.

2. A descent device according to claim 1, wherein the centrifugal brake mechanism is continuously engaged with the spool.

3. A descent device according to claim 1, wherein the biasing member is adapted to provide sufficient friction between the spool and the at least one brake assembly to prevent rotation of the spool due to the weight of an initially unwound portion of the lifeline.

4. A descent device according to claim 1, wherein the biasing member is a compression spring.

5. A descent device according to claim 4, wherein the spring is adapted to provide a force of between approximately 10 N and approximately 100 N between the spool and the at least one brake assembly.

6. A descent device according to claim 1, wherein the centrifugal brake mechanism includes a gear train including a ring gear engaged with the spool, at least one planetary gear engaged with the ring gear and a sun gear engaged with the at least one planetary gear.

7. A descent device according to claim 6, wherein a gear ratio between the ring gear and the sun gear is between approximately 4:1 and approximately 10:1.

8. A descent device according to claim 6, wherein the sun gear is rotationally engaged with a shaft that converts torque from the sun gear into a centrifugal force biasing the at least one brake assembly toward the spool.

9. A descent device according to claim 8, wherein at least one brake shoe carrier plate is rotationally engaged with the shaft and slidably engaged with the brake assembly to convert torque from the shaft into linear movement of the brake assembly in a direction substantially perpendicular to said rotational axis.

10. A descent device according to claim 9, wherein the carrier plate extends substantially perpendicularly relative to a longitudinal axis of the shaft.

11. A descent device according to claim 8, wherein a first said carrier plate is provided on one side of said at least one brake assembly and a second said carrier plate is provided on an opposite side of said at least one brake assembly.

12. A descent device according to claim 1, comprising two said brake assemblies.

13. A descent device according to claim 12, further comprising a compression spring extending between the brake assemblies to bias the brake assemblies away from one another into engagement with the spool.

14. A descent device according to claim 1, comprising a housing extending around the spool, an unwound portion of the lifeline, the centrifugal brake mechanism and the biasing member.

15. A descent device according to claim 14, wherein the housing is substantially tamperproof to inhibit tampering of components therein.
